(19) United States
(12) Patent Application Publication
(10) Pub. No.: US 2015/0380195 A1
(43) Pub. Date: Dec. 31, 2015

(54) FUSE

(71) Applicant: YAZAKI CORPORATION, Tokyo (JP)

(72) Inventors: Yusuke MATSUMOTO, Shizuoka (JP); Toshiko MASUDA, Shizuoka (JP)

(21) Appl. No.: 14/851,051

(22) Filed: Sep. 11, 2015

Related U.S. Application Data
(63) Continuation of application No. PCT/JP2014/057475, filed on Mar. 19, 2014.

(30) Foreign Application Priority Data
Mar. 21, 2013 (JP) 2013-058078

(51) Int. Cl. H01H 85/02

(52) U.S. Cl. CPC H01H 85/02; H01H 2205/002; H01H 2235/01

(57) ABSTRACT

A fuse includes: a conductive fuse body; a case housing the fuse body; and a shaft rotatably supported inside the case. The fuse body includes: first and second bus bars disposed at positions away from each other; a fusible element including one end side connected to the first bus bar, and disposed along a circumference of a circle around the center of rotation of the shaft; and a rotor electrically connecting the first and second bus bars, and provided with a movable contact point which slides over the fusible element in response to the rotation of the shaft.

### CROSS REFERENCE TO RELATED APPLICATIONS

This application is a continuation application of International Application No. PCT/JP2014/057475, filed on Mar. 19, 2014, which claims priority to Japanese Patent Application No. 2013-058078, filed on Mar. 21, 2013, the entire contents of which are incorporated by reference herein.

### BACKGROUND

1. Technical Field

The present invention relates to a fuse, and particularly to a fuse installed in a vehicle.

2. Description of the Related Art

In general, vehicles such as automobiles are supplied with electric power from batteries. Some vehicles are provided with cartridge-type fuses for protecting their power sources from short circuit or the like in electronic devices and electrical wires.

Referring to FIG. 8, an example of fuses of this kind will be-described. As shown in FIG. 8, a fuse 100 is formed from: a fuse body 110 in which a pair of electrical connectors 112 are provided to the two sides of a fusible element 111, respectively; an insulating case 120 housing the fuse body 110; a transparent cover 130 attached to an upper opening 121 of the case 120; and a spacer 140 closing a lower opening (not shown) of the case 120.

Such fuse 100 is configured such that when a current equal to or greater than a rated current value flows through the fusible element 111 of the fuse body 110, a low-melting-point metal 111A provided to the fusible element 111 melts, and the melted low-melting-point metal 111A spreads over the fusible element 111, thus lowering the melting point of the fusible element 111. This facilitates heat generation of the fusible element 111, and accordingly fuses part of the fusible element 111, thus blocking the current from flowing through the fusible element 111 (discontinuing the electrical connection).

### SUMMARY OF THE INVENTION

However, a change in a fuse capacity (ratings) of the conventional fuse 100 requires the length, width and thickness of the fuse body 111 to be changed, and as many fuse bodies 110 as multiple fuse capacities accordingly need to be prepared for use. The production of as many fuse bodies 110 as the multiple fuse capacities requires multiple press-machine dies and the like, and thus increases the production costs.

With this taken into consideration, an object of the present invention is to provide a fuse which makes it possible to reduce the production costs without changing the shape of the fusible element even when the fuse capacity (ratings) needs to be changed.

A first aspect of the present invention is a fuse including: a conductive fuse body; a case housing the fuse body; and a shaft rotatably supported inside the case, in which the fuse body includes: first and second conductive members disposed at positions away from each other; a fusible element including one end side connected to the first conductive member, and disposed along a circumference of a circle around the center of rotation of the shaft; and a rotor electrically connecting the second conductive member and the fusible element, and provided with a movable contact point which slides over the fusible element in response to the rotation of the shaft.

The fusible element may include a rotation restrictor configured to restrict a range of the rotation of the rotor.

A manipulator to be used to rotate the shaft may be provided on an outer portion of the case.

An insulating spacer may be interposed between the first conductive member and the rotor, and a spring member configured to bias the second conductive member and the rotor in a direction in which the second conductive member and the rotor come into close contact with each other may be disposed.

According to the present invention, the movable contact point of the rotor slides over the fusible element in response to the rotation of the shaft, and the length of the fusible element accordingly changes. For this reason, the fuse capacity (ratings) is variable. Thereby, even when the fuse capacity needs to be changed, the production costs can be reduced without changing the shape of the fusible element.

### BRIEF DESCRIPTION OF THE DRAWINGS

FIG. 1 is an assembly perspective view showing a fuse of an embodiment of the present invention.

FIGS. 2A to 2D are four orthogonal assembly views showing the fuse of the embodiment of the present invention.

FIG. 3 is an exploded perspective view showing the fuse of the embodiment of the present invention.

FIG. 4 is an exploded perspective view showing a first bus bar, a second bus bar and a rotor of the embodiment of the present invention.

FIGS. 5A and 5B are perspective views showing rotor positions in high-ratings and low-ratings relative to the first bus bar and the second bus bar in the embodiment of the present invention.

FIG. 6 is a circuit diagram of a fusible element of the embodiment of the present invention.

FIG. 7 is a graph showing a relationship of a resistance value of a current to a rotor angle in the embodiment of the present invention.

FIG. 8 is an exploded perspective view showing a fuse of an example of the background art.

### DESCRIPTION OF THE EMBODIMENTS

Next, referring to the drawings, a fuse of an embodiment of the present invention will be described. In the following drawings, the same or similar components are denoted by the same of similar reference signs. It should be noted, however, that: the drawings are schematic; and dimensional ratios and the like there are different from actual ones. For this reason, specific dimensions and the like shall be judged with the following descriptions taken into consideration. Furthermore, the drawings include components which are different in dimensional relationships and ratios among the drawings.

### (Configuration of Fuse)

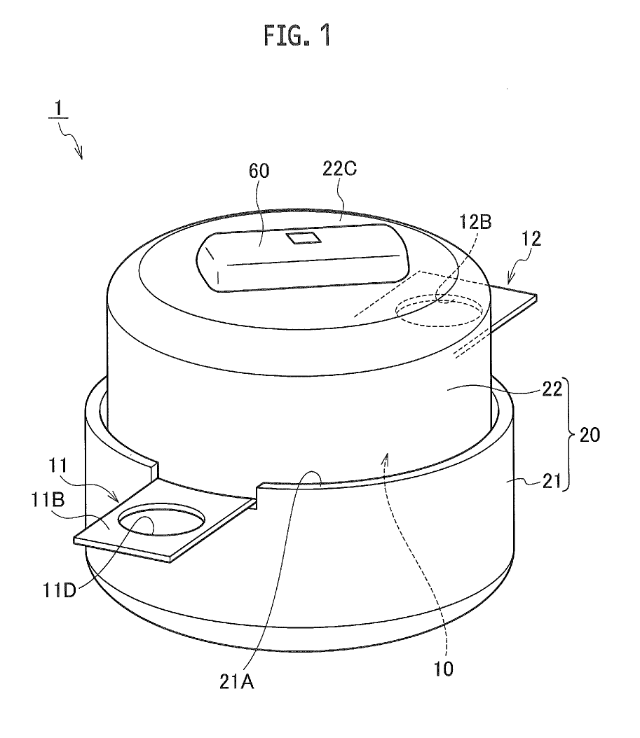

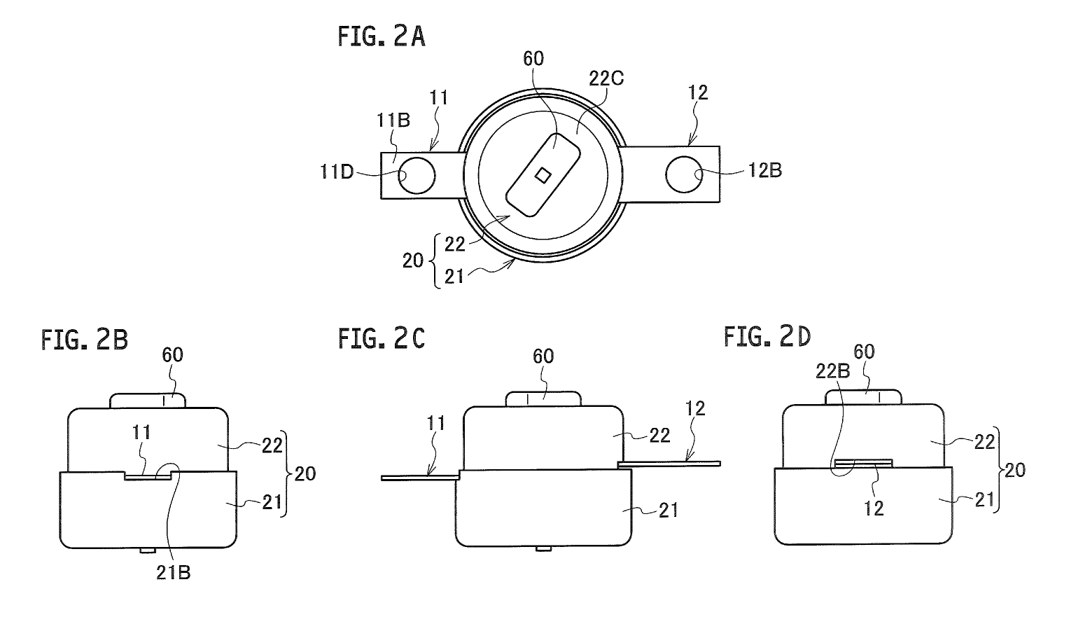

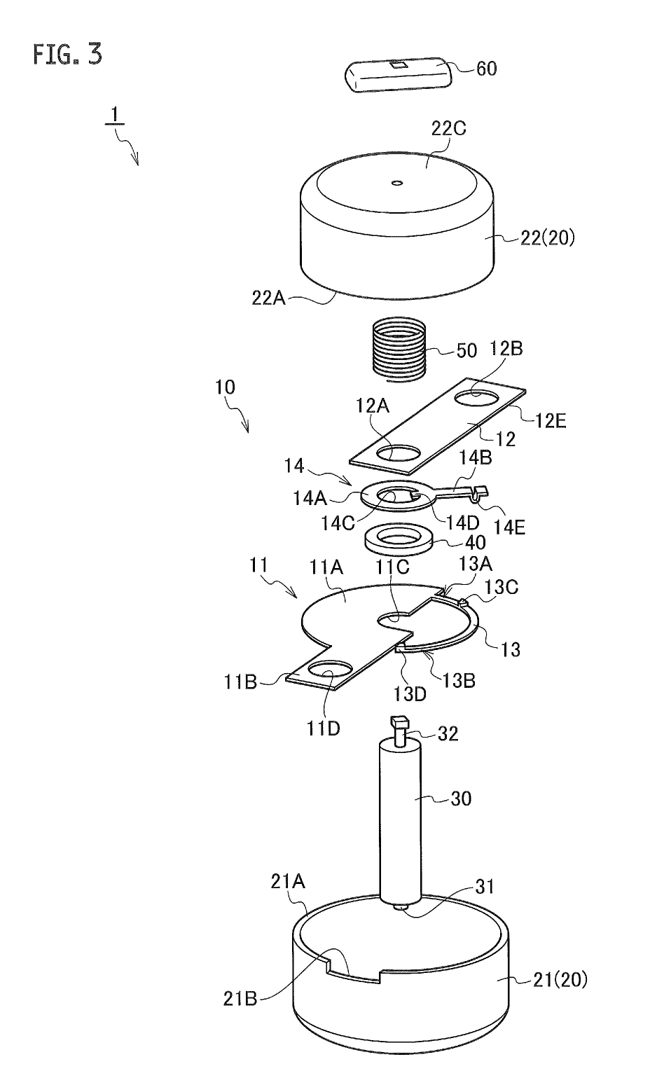

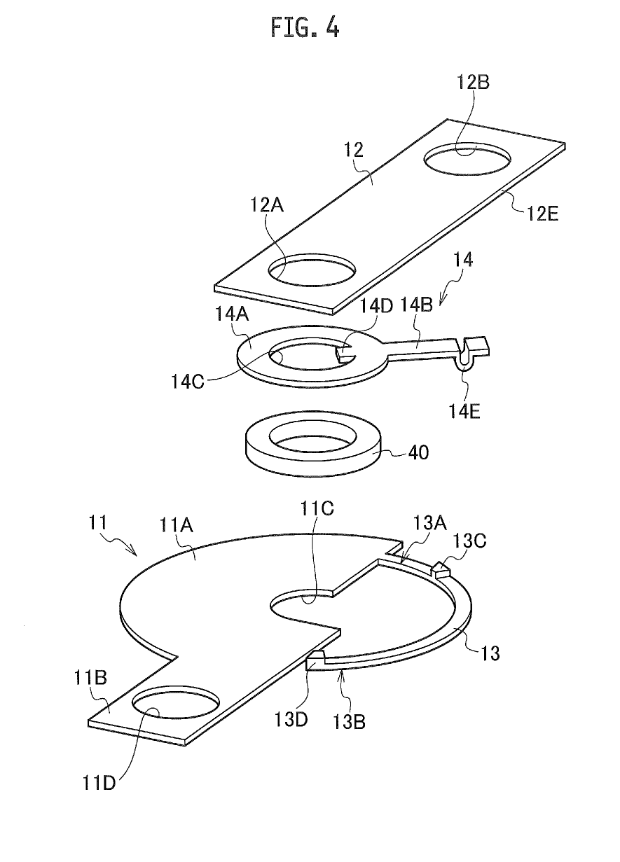

First, referring to the drawings, a configuration of the fuse 1 of the embodiment will be described. FIG. 1 is an assembly perspective view showing the fuse 1 of the embodiment. FIGS. 2A to 2D are four orthogonal assembly views showing the fuse 1 of the embodiment. FIGS. 3 and 4 are exploded perspective views showing the fuse 1 of the embodiment.

As shown in FIGS. 1 to 4, the fuse 1 includes: a conductive fuse body 10 connected to an electrical connector (not shown) of a power source such as a battery; and a case 20 housing the fuse body 10; and a shaft 30 rotatably supported inside the case 20.

### (Fuse Body)

The fuse body 10 blocks the flow of electricity from the power source, such as a battery, to various electronic devices. The fuse body 10 includes: first and second bus bars 11, 12, as first and second conductive members, disposed at positions away from each other; a fusible element 13 capable of blocking the electricity flow; and a rotor 14 electrically connecting the second bus bar 12 and the fusible element 13.

The first bus bar 11 is a part which is connected to the electrical connector (not shown), and into which a current is inputted from the electrical connector (not shown). The first bus bar 11 is made from a plate-shaped conductive member (for example, a piece of metal). An insulating spacer 40 is interposed between the first bus bar 11 and the rotor 14.

The first bus bar 11 is formed from: an inner area 11A disposed inside the case 20; and an outer connector 11B disposed outside the case 20. The inner area 11A is shaped almost like a semicircle in a plan view. A shaft insertion portion 11C into which to insert the shaft 30 is formed in the inner area 11A. On the other hand, the outer connector 11B continues to the inner area 11A, and is shaped almost like a rectangle in a plan view. An attachment hole 11D into which to insert a fastener (not shown) such as a bolt is formed in the outer connector 11B. The fastener is used to attach the outer connector 11B to the electrical connector (not shown).

The second bus bar 12 is a part which is connected to the electrical connector (not shown), and from which the current is outputted to the electrical connector (not shown). The second bus bar 12 is made from a plate-shaped conductive member (for example, a piece of metal). A spring 50 as a spring member is disposed above the second bus bar 12. The spring 50 biases the second bus bar 12 and the rotor 14 in a direction in which the second bus bar 12 and the rotor 14 come into close contact with each other.

The second bus bar 12 is shaped almost like a rectangle in a plan view. A shaft insertion hole 12A and an attachment hole 12B are formed in the second bus bar 12. The shaft 30 is inserted into the shaft insertion hole 12A. A fastener (not shown) such as a bolt used to attach the second bus bar 12 to the electrical connector (not shown) is inserted into the attachment hole 12B.

The fusible element 13 is provided integrally with the first bus bar 11. The fusible element 13 is disposed along a circumference of a circle around the center of rotation of the shaft 30. In other words, the fusible element 13 is formed around the shaft 30, and is shaped like an arc.

One end 13A of the fusible element 13 is connected to the inner area 11A of the first bus bar 11. The other end 13B of the fusible element 13 is slightly away from the inner area 11A of the first bus bar 11. Stoppers 13C, 13D as rotation restrictors configured to restrict a range of rotation of the rotor 14 are provided to the one and other ends 13A, 13B of the fusible element 13, respectively.

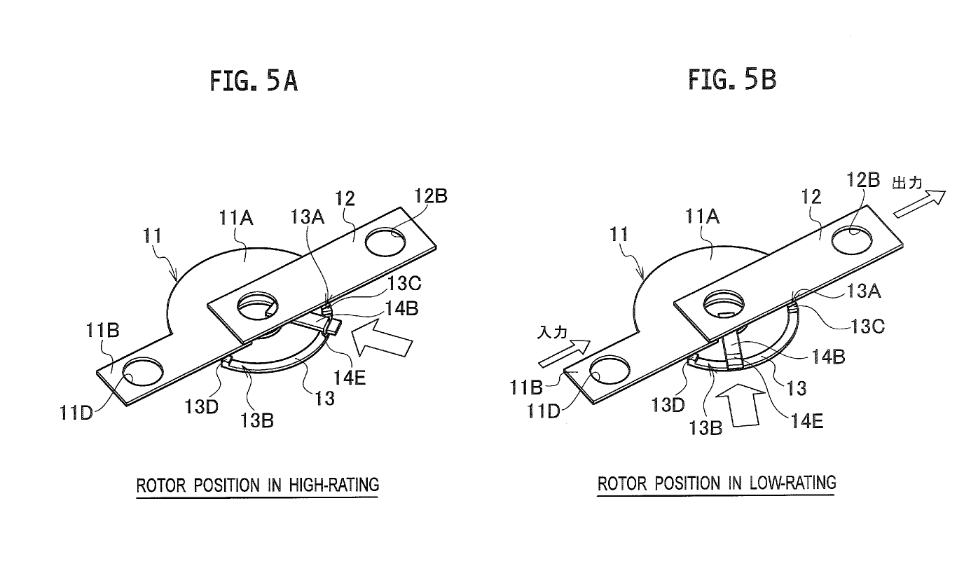

The rotor 14 is made from a plate-shaped conductive member (for example, a piece of metal). The rotor 14 is disposed between the spacer 40 and the second bus bar 12, and electrically connects the second bus bar 12 and the fusible element 13. The rotor 14 changes a capacity of the current to be blocked by the fusible element 13 (hereinafter referred to as a fuse capacity) in accordance with its movement between a high-ratings position (see FIG. 5A) where the fusible element 13 blocks a high rated current and a low-ratings position (see FIG. 5B) where the fusible element 13 blocks a low rated current.

The rotor 14 includes: a frame body 14A to rotate around the shaft 30; and a movable piece 14B sticking out from the frame body 14A. A shaft insertion hole 14C into which to insert the shaft 30 is formed in the frame body 14A. A fixing portion 14D sticking out toward the shaft 30 and configured to be fixed to a hole portion (not shown) in the shaft 30 is provided to the peripheral edge of the shaft insertion hole 14C. On the other hand, a movable contact point 14E sticking out toward the fusible element 13 and configured to slide over the fusible element 13 is formed in the tip end of the movable piece 14B.

### (Case)

The case 20 is shaped like a cylinder, and is made of insulating synthetic resin or the like. The case 20 includes: an under case 21; and an upper case 22 attached to an upper opening 21A of the under case 21.

The shaft 30 is provided inside the under case 21 and the upper case 22, and extends in a case-axis direction. A lower end 31 of the shaft 30 is supported by the under case 21, and an upper end 32 of the shaft 30 penetrates through the upper case 22.

A cut 21B in which to dispose the first bus bar 11 is formed in the upper opening 21A of the under case 21. On the other hand, a cut 22B in which to dispose the second bus bar 12 is formed in a lower opening 22A of the upper case 22. A manipulator 60 to be used to manipulate rotation of the rotor 14 using the shaft 30 from outside the case 20 is provided on an upper surface 22C of the upper case 22.

The upper end 32 (head) of the shaft 30 as penetrating through the upper case 22 is fixed to the manipulator 60. Rotational manipulation of the manipulator 60 by the operator rotates the shaft 30, and accordingly rotates the rotor 14 fixed to the shaft 30.

### (Movement of Rotor)

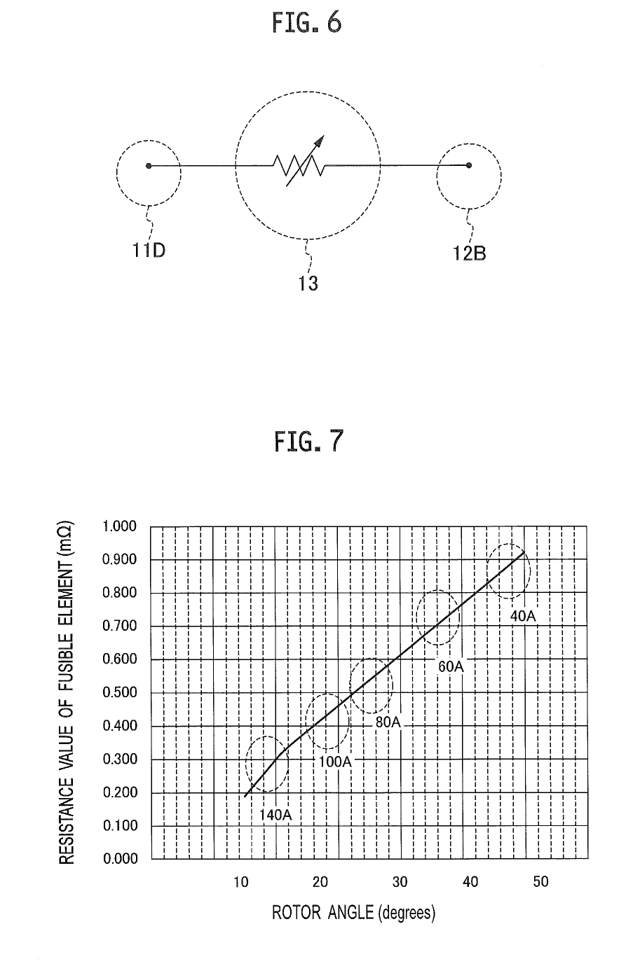

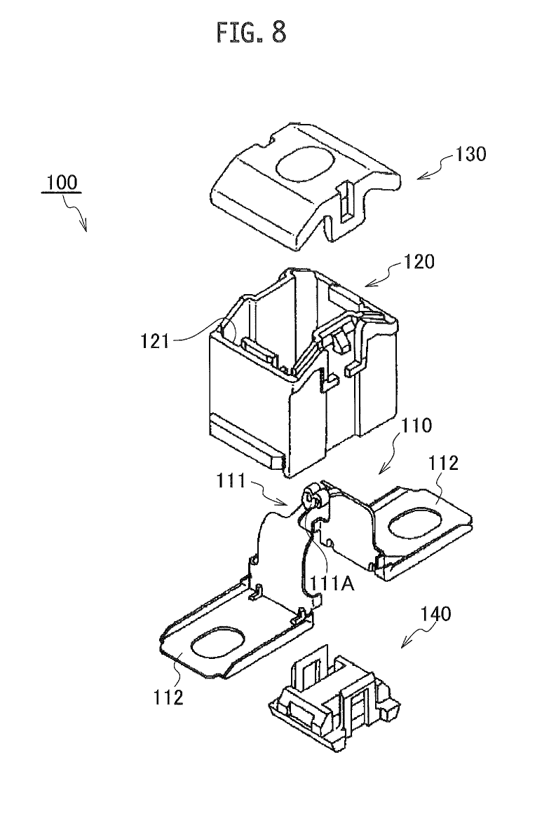

Next, movement of the rotor 14 will be described. FIG. 5A is a perspective view showing a high-ratings position of the rotor 14 relative to the first bus bar 11 and the second bus bar 12. FIG. 5B is a perspective view showing a low-ratings position of the rotor 14 relative to the first bus bar 11 and the second bus bar 12. FIG. 6 is a circuit diagram of the fusible element 13. FIG. 7 is a graph showing a relationship of a resistance value of the current to an angle of the rotor 14.

As shown in FIG. 5A, the high-ratings position of the rotor 14 is configured such that the movable contact point 14E of the movable piece 14B is situated closer to the one end 13A of the fusible element 13 so that the distance from the one end 13A of the fusible element 13 to the movable piece 14B is shorter. This decreases the resistance value of the current flowing through the fusible element 13, and makes the fusible element 13 capable of blocking the current, if equal to or greater than the thus-set high rated current value, from flowing through the fusible element 13.

As shown in FIG. 5B, the low-ratings position of the rotor 14 is configured such that the movable contact point 14E of the movable piece 14B is situated closer to the other end 13B of the fusible element 13 so that the distance from the one end 13A of the fusible element 13 to the movable piece 14B is longer. This increases the resistance value of the current flowing through the fusible element 13, and makes the fusible element 13 capable of blocking the current, if equal to or greater than the thus-set low rated current value, from flowing through the fusible element 13.

In other words, as shown in FIG. 6, a change in the length of the current-flowing fusible element 13 by changing the angle of the rotor 14 (the direction of the movable piece 14B to the fusible element 13) changes the substantial resistance value of the fusible element 13. That is to say, the fuse capacity (ratings) is variable by changing the resistance value of the current flowing the fusible element 13 from the first bus bar 11 (the attachment hole 11D) on the current input side to the second bus bar 12 (the attachment hole 12B) on the current output side.

For example, when, as shown in FIG. 7, the angle of the rotor 14 to a side edge 12E of the second bus bar 12 (hereinafter referred to as a rotor angle) is at approximately 15 degrees, the resistance value of the current flowing through the fusible element 13 is at approximately 0.300 milliohms, thus corresponding to a 140-ampere battery. Incidentally, the relationship of the resistance values of the current to other rotor angles is as shown in FIG. 7. As shown in FIG. 7, a change in the rotor angle makes the fuse applicable to batteries of various capacities since the change in the rotor angle enables the fuse capacity to be changed through the change in the resistance value of the current.

### (Operation/Working-Effect)

The foregoing embodiment can change the fuse capacity (ratings) since the slide of the movable contact point 14E of the rotor 14 over the fusible element 13 in response to the rotation of the shaft 30 change the length of the fusible element 13. In other words, since the slide changes the fuse capacity, the embodiment makes it unnecessary to change the length, width, thickness and the like of the fusible element 13, and does not require multiple press-machines dies or the like. Accordingly, the embodiment can reduce production costs. Thereby, even when the fuse capacity needs to be changed, the embodiment can reduce the production costs without changing the shape of the fusible element 13.

In the embodiment, the one end 13A and the other end 13B of the fusible element 13 are provided with the stoppers 13C, 13D, respectively. This makes the movable contact point 14E come into contact with the stoppers 13C, 13D, and the range of rotation of the rotor 14 accordingly can be restricted.

In the embodiment, the manipulator 60 is provided on the outer portion of the case 20. Thereby, the fuse capacity (ratings) can be easily changed from outside the case 20.

In the embodiment, the spacer 40 is interposed between the first bus bar 11 and the rotor 14. This makes the first bus bar 11 and the second bus bar 12 securely out of contact with each other.

In the embodiment, the spring 50 configured to bias the second bus bar 12 and the rotor 14 in the direction in which the second bus bar 12 and the rotor 14 come into close contact with each other is disposed above the second bus bar 12. This makes it possible to prevent vibrations and the like which would otherwise occur between the first bus bar 11 and the rotor 14, as well as between the second bus bar 12 and the rotor 14.

In the embodiment, the fusible element 13 is provided integrally with the first bus bar 11. This makes contributions to making the number of components smaller than the fusible element 13 which would be provided separately from the first bus bar 11.

In the embodiment, the shaft insertion portion 11C is formed in the first bus bar 11; the shaft insertion hole 12A is formed in the second bus bar 12; and the shaft insertion hole 14C is formed in the rotor 14. In other words, the holes into which to insert the shaft 30 are formed in the members, respectively. This makes it possible to align the members with the shaft 30 at precise positions, and accordingly to produce the fuse 1 with high precision.

### (Other Embodiments)

Although as described above, the contents of the present invention have been disclosed through the embodiment of the present invention, the descriptions and the drawings which are part of this disclosure shall not be construed as limiting the present invention. This disclosure will make various alternative embodiments, examples and operational techniques clear to those skilled in the art.

For example, the embodiment of the present invention may be changed as follows. To put it concretely, although the embodiment in which the first bus bar 11 is on the current input side and the second bus bar 12 is on the current output side has been described, the present invention is not limited to this embodiment. The first bus bar 11 may be on the current output side, while the second bus bar 12 may be on the current input side.

Furthermore, although the embodiment in which the fusible element 13 is formed integrally with the first bus bar 11 has been described, the present invention is not limited to this embodiment. The fusible element 13 may be formed integrally with the second bus bar 12. Incidentally, the fusible element 13 does not have to be formed integrally with the first bus bar 11 or the second bus bar 12. For example, the fusible element 13 may be connected to the first bus bar 11 or the second bus bar 12 by welding or the like.

Moreover, although the embodiment in which the stoppers 13C, 13D are provided respectively to the one end 13A and the other end 13B of the fusible element 13 has been described, the present invention is not limited to this embodiment. Neither the stopper 13C nor 13D has to be provided to the fusible element 13. Otherwise, a stopper may be provided to one of the one end 13A and the other end 13B of the fusible element 13. Incidentally, neither the stopper 13C nor 13D has to be provided to the fusible element 13. Stoppers may be provided, for example, on the inner peripheral surface of the case 20 on condition that the stoppers are capable of restricting the range of rotation of the rotor 14.

Besides, although the embodiment in which the length of the fusible element 13 is variable in response to the rotation of the rotor 14 has been described, the present invention is not limited to this embodiment. For example, the area of contact between the fusible element 13 and the movable contact point 14E may be variable in response to the rotation of the rotor 14.

In addition, although the embodiment in which the manipulator 60 is provided on the upper surface 22C of the upper case 22 has been described, the present invention is not limited to this embodiment. The rotor 14 may be capable of being rotationally manipulated using the shaft 30. For example, the rotor 14 may be provided to the bottom surface of the under case 21, or to the outer peripheral surface of the case 20.

In this respect, amperes or the like corresponding to the angles of the rotor 14 may be displayed on the upper surface 22C of the upper case 22 on which the manipulator 60 is provided. Otherwise, for each angle of the rotor 14, positioning means (a slight recess and protrusion, for example) for positioning the rotor 14 may be provided to the fusible element 13.

It is a matter of course that as described above, the present invention includes various embodiments and the like which have not been described herein. For this reason, the technical scope of the present invention is determined only by the matter to define the invention concerning the scope of claims which is considered as appropriate based on the foregoing descriptions.

What is claimed is:

1. A fuse comprising:
a conductive fuse body;
a case housing the fuse body; and
a shaft rotatably supported inside the case, wherein the fuse body includes
first and second conductive members disposed at positions away from each other,
a fusible element including one end side connected to the first conductive member, and disposed along a circumference of a circle around a center of rotation of the shaft, and
a rotor electrically connecting the second conductive member and the fusible element, and provided with a movable contact point configured to slide over the fusible element in response to the rotation of the shaft.

2. The fuse according to claim 1, wherein
the fusible element includes a rotation restrictor configured to restrict a range of the rotation of the rotor.

3. The fuse according to claim 1, wherein
a manipulator to be used to rotate the shaft is provided on an outer portion of the case.

4. The fuse according to claim 1, wherein
an insulating spacer is interposed between the first conductive member and the rotor, and
a spring member configured to bias the second conductive member and the rotor in a direction in which the second conductive member and the rotor come into close contact with each other is disposed.
